(19) United States
(12) Patent Application Publication
(10) Pub. No.: US 2018/0039033 A1
(43) Pub. Date: Feb. 8, 2018

(54) MULTI-CHANNEL OPTICAL MODULE AND MANUFACTURING METHOD THEREOF

(71) Applicant: ELECTRONICS AND TELECOMMUNICATIONS RESEARCH INSTITUTE, Daejeon (KR)

(72) Inventors: Mi Ran PARK, Daejeon (KR); O Kyun KWON, Daejeon (KR); Hyun Soo KIM, Daejeon (KR); Jong Sool JEONG, Daejeon (KR)

(73) Assignee: ELECTRONICS AND TELECOMMUNICATIONS RESEARCH INSTITUTE, Daejeon (KR)

(21) Appl. No.: 15/786,197

(22) Filed: Oct. 17, 2017

Related U.S. Application Data
(62) Division of application No. 14/841,158, filed on Aug. 31, 2015.

(30) Foreign Application Priority Data
Sep. 1, 2014 (KR) 10-2014-0115621

(51) Int. Cl. G02B 6/42

(52) U.S. Cl. CPC G02B 6/4214; G02B 6/4249; G02B 6/4221; G02B 6/4257

(57) ABSTRACT

Provided herein is a multi-channel optical module that transmits or receives an optical signal of multi-channels and a manufacturing method thereof, the multi-channel optical module including a multi-channel optical fiber block configured to transmit an optical signal, a submount including an array optical receiving element unit configured to receive the optical signal; and a mirror unit arranged on a metal optical bench and configured to induce the optical signal transmitted from the multi-channel optical fiber block to the array optical receiving element unit, wherein for the inducement of the optical signal to the array optical receiving element unit, the mirror unit is passively aligned with the array optical receiving element unit, and the multi-channel optical fiber block is actively aligned with the mirror unit.

### CROSS-REFERENCE TO RELATED APPLICATIONS

This is a divisional application of U.S. patent application Ser. No. 14/841,158, filed on Aug. 31, 2015. Further, this application claims priority to and the benefit of Korean Patent Application No. 10-2014-0115621, filed on Sep. 1, 2014, in the Korean Intellectual Property Office. The entire contents of these prior U.S and Korean applications are hereby incorporated by reference.

### BACKGROUND

### Field of Invention

Various embodiments of the present disclosure relate to a multi-channel optical module and a manufacturing method thereof, and more particularly to a multi-channel optical module configured to transmit and/or receive an optical signal for optical communication of multiple channels (hereinafter referred to as an optical signal), and a manufacturing method thereof.

### Description of Related Art

As various kinds of multimedia services are emerging these days, the need to exchange massive amounts of information has increased, which has caused an increase of amount of data being transmitted through a network. In response to such increased amount of data, an optical communication system of wavelength division multiplexing (hereinafter referred to as WDM) is being widely used. The WDM method is a method of transceiving data of numerous wavelength bands through one optical fiber after multiplexing or de-multiplexing.

In such a WDM-based optical communication system, a multi-channel optical module such as a transmitter optical sub assembly (TOSA), receiver optical sub assembly (ROSA), or optical sub assembly (OSA) is necessary in order to multiplex a data channel. Especially, since a metro network system that transmits massive data needs to have a long data transmission distance and fast data transmission speed, it is necessary to provide a high capacity high performance multi-channel optical module.

The multi-channel optical module may be a data receiving device that converts optical signals being received in parallel through an optical fiber or de-multiplexer into electric signals or a data transmitting device that converts electric signals into optical signals and transmits the converted optical signals through an optical fiber or multiplexer. Such a multi-channel optical module performs alignment of adjusting the arrangement of elements that form the device in order to minimize optical signal loss in the transmitting or receiving process.

Such alignments may include passive alignments and active alignments. A passive alignment is an alignment method of fixating each element of a multi-channel optical module at predetermined positions on a substrate, whereas an active alignment is an alignment method of aligning each element of a multi-channel optical module to find a point where the efficiency of an optical signal being transmitted or received is the highest by auto or manual operation of an alignment equipment, laser welding equipment, etc, in consideration of the strength and weakness of the optical signal, beam pattern, and method of transmitting or receiving the optical signal.

The passive alignment costs less since the alignment method and packaging of each element is simple, but is less precise and reliable. On the other hand, the active alignment is very precise and reliable since it considers the optical power, beam pattern, and receiving efficiency of each element, but it takes a great deal of manufacturing time and cost.

### SUMMARY

Therefore, a purpose of various embodiments of the present disclosure is to provide a multi-channel optical module capable of minimizing optical signal loss and reducing the manufacturing cost, and a manufacturing method thereof

Another purpose of the various embodiments of the present disclosure is to provide a multi-channel optical module capable of minimizing the coupling loss caused by distances between components and alignment errors.

In an embodiment, there is provided multi-channel optical module including: a multi-channel optical fiber block configured to transmit an optical signal; a submount comprising an array optical receiving element unit configured to receive the optical signal; and a mirror unit arranged on a metal optical bench and configured to induce the optical signal transmitted from the multi-channel optical fiber block to the array optical receiving element unit, wherein for the inducement of the optical signal to the array optical receiving element unit, the mirror unit is passively aligned with the array optical receiving element unit, and the multi-channel optical fiber block is actively aligned with the mirror unit.

In the embodiment, the passive alignment may be performed by visually confirming a proceeding path of visible light.

In the embodiment, one side of the metal optical bench may be depressed towards its inside, and a submount may be arranged on the depressed part of the metal optical bench.

In the embodiment, a thickness of the metal optical bench may correspond to a focal distance of the second array lens, a thickness of a submount, and a thickness of the array optical receiving element unit.

In the embodiment, the device may further include a housing bottom where the submount and the metal optical bench are mounted.

In the embodiment, the multi-channel optical fiber block may be mounted on the housing bottom.

In the embodiment, the mirror unit includes an incidence surface through which the optical signal enters the mirror unit; a reflective surface where the optical signal that entered through the incidence surface is totally reflected; and an exit surface from which the totally reflected optical signal exits towards the array optical receiving element unit.

In the embodiment, the mirror unit may be formed by bonding a first mirror piece having a reflective surface of 45°; and a second mirror piece having a reflective surface of 45°.

In the embodiment, the mirror unit may further include a first array lens formed on the incidence surface; and a second array lens formed on the exit surface, wherein the optical signal may enter the incidence surface through the first array lens, and may exit the second array lens through the exit surface.

In the embodiment, for the inducement of the optical signal from the first array lens to the second array lens, the first array lens and the second array lens may be passively aligned to each other.

In the embodiment, the passive alignment may be performed by visually confirming a proceeding path of visible light.

In the embodiment, the reflective surface may be coated with a high reflective dielectric material in a wavelength that totally reflects the optical signal.

In the embodiment, at least a part of the visible light may penetrate the reflective surface and proceed.

In another embodiment, there is provided a method for manufacturing a multi-channel optical module including forming a mirror unit by passively aligning a first array lens and a second array lens to each other such that an optical signal that enters from the first array lens formed on an incidence surface of a mirror reaches to the second array lens formed on an exit surface of the mirror; passively aligning the mirror unit to an array optical receiving element unit such that the optical signal that exits the second array lens reaches a predetermined position of the array optical receiving element unit; and actively aligning a multi-channel array optical fiber block configured to transmit the optical signal to the first array lens of the mirror unit using the optical signal such that the optical signal reaches the array optical receiving element.

In the embodiment, the array optical receiving element unit on a submount may be placed on one side of a metal optical bench depressed towards the inside, and the mirror unit may be arranged and fixed on the metal optical bench.

In the embodiment, the passive alignment of the first array lens and the second array lens and the passive alignment of the mirror unit and the array optical receiving element unit may be performed by visually confirming a proceeding path of visible light.

In the embodiment, a thickness of the metal optical bench may be formed to correspond to a focal distance of the second array lens, a thickness of the submount and a thickness of the array optical receiving element unit.

According to the aforementioned various embodiments, there is provided a multi-channel optical module wherein an optical coupling efficiency between elements have been improved by combining passive alignment and active alignment.

Furthermore by combining the passive alignment and active alignment, it is possible to precisely align elements of the multi-channel optical module, minimize optical signal loss, and reduce the manufacturing cost of the multi-channel optical module.

Furthermore, it is possible to apply the multi-channel optical module to single mode signal transmission for high speed long distance data transmission of massive data.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a perspective view illustrating a submount configuration of a multi-channel optical module, according to an embodiment of the present disclosure;

FIG.2 is a perspective view illustrating a method for arranging the submount illustrated in FIG. 1 together with a metal optical bench;

FIG. 3 is a side view illustrating a method for forming a mirror having a reflective surface of 45°;

FIG. 4 is a side view illustrating in detail a configuration of the mirror of FIG. 3;

FIG. 5 is a perspective view illustrating a method for forming and aligning a mirror on the submount and metal optical bench illustrated in FIG. 2;

FIG. 6 is a perspective view illustrating a final configuration of a multi-channel optical module according to an embodiment of the present disclosure; and

FIG. 7 is a flowchart schematically illustrating a method for manufacturing a multi-channel optical module according to an embodiment of the present disclosure.

### DETAILED DESCRIPTION

Hereinafter, embodiments will be described in greater detail with reference to the accompanying drawings. Embodiments are described herein with reference to cross-sectional illustrations that are schematic illustrations of embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but may include deviations in shapes that result, for example, from manufacturing. In the drawings, lengths and sizes of layers and regions may be exaggerated for clarity. Like reference numerals in the drawings denote like elements.

Terms such as ‘first’ and ‘second’ may be used to describe various components, but they should not limit the various components. Those terms are only used for the purpose of differentiating a component from other components. For example, a first component may be referred to as a second component, and a second component may be referred to as a first component and so forth without departing from the spirit and scope of the present disclosure. Furthermore, ‘and/or’ may include any one of or a combination of the components mentioned.

Furthermore, a singular form may include a plural from as long as it is not specifically mentioned in a sentence. Furthermore, “include/comprise” or “including/comprising” used in the specification represents that one or more components, steps, operations, and elements exist or are added.

Furthermore, unless defined otherwise, all the terms used in this specification including technical and scientific terms have the same meanings as would be generally understood by those skilled in the related art. The terms defined in generally used dictionaries should be construed as having the same meanings as would be construed in the context of the related art, and unless clearly defined otherwise in this specification, should not be construed as having idealistic or overly formal meanings.

It is also noted that in this specification, “connected/coupled” refers to one component not only directly coupling another component but also indirectly coupling another component through an intermediate component. On the other hand, “directly connected/directly coupled” refers to one component directly coupling another component without an intermediate component.

Examples of internal optical coupling methods for an optical receiving module (or optical transmitting module) that is a type of multi-channel optical module include a method for directly coupling an optical receiving element to a multi-channel optical fiber connector having a mirror with an predetermined incident angle (for example, 45°), a method for coupling an optical receiving element having a mirror with a predetermined incident angle to a polymer optical waveguide and connecting the polymer optical waveguide to a multi-channel optical fiber connector; a method for coupling an optical receiving element to a polymer optical waveguide perpendicularly and connecting the polymer optical waveguide to a multi-channel optical fiber connector, and a method of coupling an optical receiving element fixated to a plastic package perpendicularly to a multi-channel optical connector.

Of the aforementioned methods, in the method of coupling an optical receiving element to a polymer optical waveguide having a mirror with a predetermined incident angle (for example, 45°) and the connecting the polymer optical waveguide to a multi-channel optical fiber connector, it is easy to form the mirror, and it is possible to embed an optical coupler, optical switch, and WDM (Wavelength Division Multiplexing) element and the like in the polymer optical waveguide, and thus it is advantageous in terms of expandability.

Of the aforementioned methods, the method for coupling an optical receiving element to a polymer optical waveguide having a mirror of a predetermined incident angle (for example, 45°) and connecting a polymer optical waveguide to a multi-channel optical fiber connector is advantageous in terms of expandability, since it is relatively easy to form a mirror and embed an optical coupler, optical switch, and WDM (Wavelength Division Multiplexing) element and the like to the polymer optical waveguide.

However, in such an optical receiving module having a two dimensional optical coupling structure, there occurs much coupling loss due to a distance between the multi-channel optical fiber and optical detector, thereby not providing sufficient efficiency.

Hereinafter, explanation will be made on manufacturing a multi-channel optical receiving module by combining the active alignment method with the passive alignment method, thereby the adopting the active alignment method minimizing the coupling loss between elements and ultimately improving the optical coupling efficiency of the multi-channel optical receiving module. Furthermore, the adopting the passive alignment method makes it possible to reduce the packaging-cost for manufacturing the multi-channel optical receiving module.

Meanwhile, in the present embodiment, a multi-channel optical receiving module is explained as an example of the multi-channel optical module, but it would be obvious to those skilled in the art that there is no limitation thereto. For example, the embodiments of the present disclosure wherein the passive alignment and active alignment are combined and used can be easily applied to an optical transmitting module as well.

The multi-channel optical module that will be explained hereinafter is a multi-channel optical transmitting module or optical receiving module integrated with surface emitting laser diodes or surface receiving photo detectors and applied to optical transceiver and highly integrated multifunctional optical sub module platform for use in access networks based on a next generation WDM or TDM (Time Division Multiplexer) providing an optical internet service of 10 gigabyte or more.

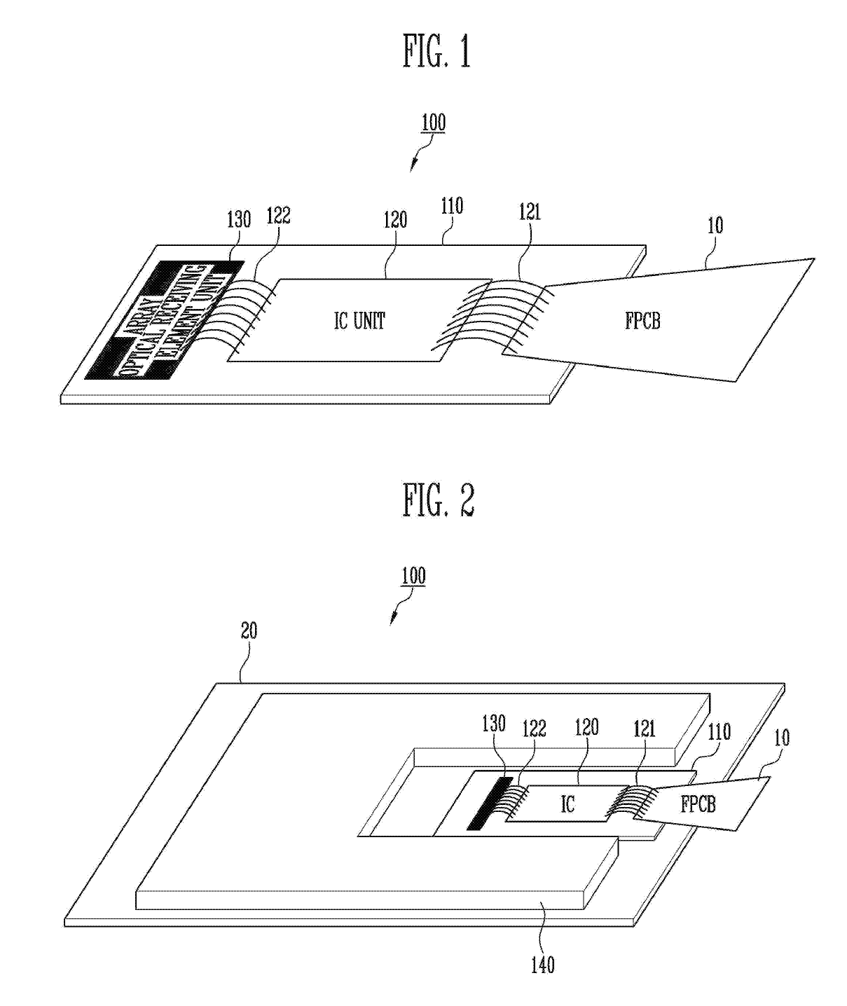

FIG. 1 is a perspective view illustrating a submount of a multi-channel optical module according to an embodiment of the present disclosure. With reference to FIG. 1, on a submount 110 of a multi-channel optical module 100, an array IC unit 120 and array optical receiving element unit 130 are mounted.

The array IC unit 120 may be an array TIA (trans-impedance amplifier) connected to an FPCB 10 by wire bonding 121.

Although not illustrated in the figures, a DC electrode of the array IC unit 120 may be connected to the FPCB 10 by wire bonding through a transmission line (hereinafter referred to as a transmission path) formed on the submount 110.

The array optical receiving element unit 130 includes a plurality of optical receiving elements in the form of an array. The plurality of optical receiving elements are monolithically integrated in the array optical receiving element unit 130, and the optical receiving elements may be for example photodiodes. The array optical receiving element unit 130 is electrically connected to the array IC unit 120 through wire bonding 122.

The array IC unit 120 and array optical receiving element unit 130 are mounted on the submount 110. In an embodiment, the FPCB 10 may be mounted on the submount 110.

Meanwhile, herein, only the array IC unit 120, array optical receiving element unit 130 and FPCB 10 were exemplified as the components of the submount 110, but there is no limitation thereto, and thus, the submount 110 may further include other components well known in the field.

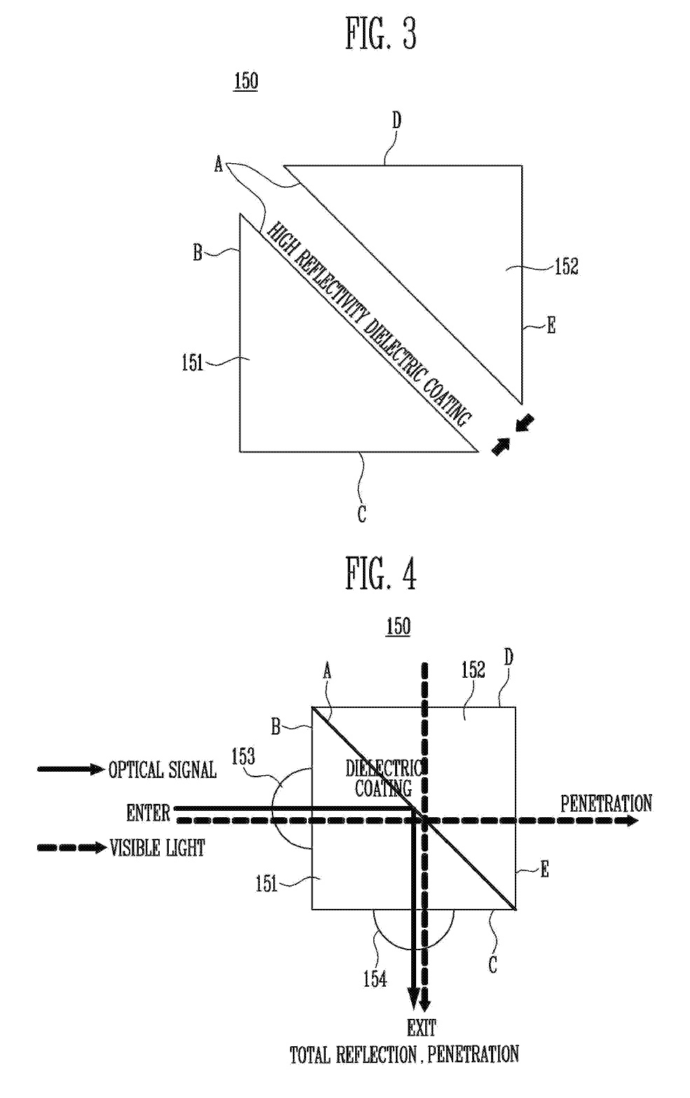

FIG. 2 is a perspective view illustrating a method of arranging the submount illustrated in FIG. 1 together with a metal optical bench. With reference to FIG. 2, the submount 110 of FIG. 1 is arranged on a housing bottom 20 together with the metal optical bench 140.

The metal optical bench 140 has a structure wherein one side is depressed and mounted on the housing bottom 20. In an embodiment, the metal optical bench 140 may have a structure of ‘ [symbol] ’ form with one side depressed.

The submount 110 is mounted on the housing bottom 20 and arranged on the depressed part of the metal optical bench 140.

In FIG. 2, the thickness of the metal optical bench 140 is more than the thickness of the submount 110. In an embodiment, the thickness of the metal optical bench 140 may be determined with reference to sum of a focal distance of the array lens 154 (see FIG. 4), the thickness of the optical receiving element on the submount 110, and the thickness of the submount 110.

In an embodiment, the housing bottom 20 may be a bottom 20 of an XMD MSA (Multi-Source Agreement) form-factor.

FIG. 3 and FIG. 4 are side views illustrating in detail a mirror. With reference to FIG. 3, the mirror 150 may be formed by bonding a first mirror piece 151 and a second mirror piece 152. The first mirror piece 151 has a reflective surface A coated with a high reflective dielectric material, incidence surface B, and exit surface C coated with an anti-reflective material. The second mirror piece 152 has an incidence surface D, an exit surface E, and a reflective surface A. Herein, the reflective surfaces A of the mirrors may be the reflective surfaces having an incident angle of 45° as illustrated in FIG. 3. Unlike the first mirror piece 151, the second mirror piece 152 may not be coated with a high reflective material and an anti-reflective material. In an embodiment, the mirror 150 may have a cubic form made by bonding the first mirror piece 151 and second mirror piece 152.

The mirror 150 includes the reflective surface A having a predetermined incident angle inside thereof In an embodiment, the predetermined incident angle may be 45°.

The reflective surface A of the mirror 150 is coated with a material that totally reflects only a certain wavelength band of an optical signal. In an embodiment, the material coated on the reflective surface A may be a high reflective (HR) dielectric material that totally reflects a wavelength of 1330 nm or 1550 nm used in optical communication.

Meanwhile, the incidence surface B and exit surface C of the mirror 150 are coated with an anti-reflective material. In FIG. 3, the incidence surface B of the mirror 150 is a left side surface of the mirror 150 where an optical signal or visible light enters, and the exit surface C is a bottom surface that faces the array optical receiving element unit 130 where an optical signal or visible light exits from the mirror 150 and enters the array optical receiving element unit 130.

With reference to FIG. 4, the mirror 150 includes a first mirror piece 151, second mirror piece 152, and array lens 153, 154.

The mirror 150 is configured such that an optical signal entering to the incidence surface B enters as a parallel light to the reflective surface A with an angle of 45° and is totally reflected by the reflective surface A with an angle of 45°, and exits through the exit surface C.

On the contrary, if a visible light enters to the incidence surface B and enters to the reflective surface A as a parallel light with an angle of 45°, some of the visible light is reflected and exits through the exist surface C and another is penetrated through the reflective surface A and exits through the exit surface E due to the high reflective dielectric material coated on the reflective surface A. Furthermore, if a visible light enters to the incidence surface D and enters to the reflective surface A, some of the visible light is reflected by the reflective surface A and exits through the exit surface E, and another is penetrated through the reflective surface A and exits through the exit surface C. For this purpose, the first mirror piece 151 and the second mirror piece 152 having an incident angle of 45° are bonded together to form the mirror 150 of a cubic form.

The part of the first mirror piece 151 and the second mirror piece 152 that contact each other form the reflective surface A. The left surface of the first mirror piece 151 is the incidence surface B where an array lens 153 is formed. The bottom surface of the first mirror piece 151 is an exit surface C where another array lens 154 is formed.

As explained above, the light source (optical signal) enters to the incidence surface B through the array lens 153, and then reflected by the reflective surface A, and then exits to the array lens 154 through the exit surface C.

For this purpose, the reflective surface A of the mirror 150 may be configured such that it is coated with a high reflective dielectric material, and that has an incident angle of 45°. For example, regarding the internal reflectivity characteristics in a case where the incident angle of the reflective surface A is 45°, when a parallel light that is parallel to the housing bottom 20 enters, the reflective surface A satisfies the total reflection conditions of the Snell's Law n 1 sin θ1=n2 sin θ2, and thus light of all wavelengths proceed towards the exit surface C. However, the reflective surface A having an incident angle of 45° may be coated with a high reflective dielectric material of a wavelength corresponding to the optical signal to totally reflect the optical signal, to reflect some of the visible light, and to penetrate another visible light, thereby facilitating the path. For example, the optical signal may be an optical signal of a long wavelength used in optical communication, that is, a wavelength of c-band or L-band (ex. 1310 nm, 1550 nm or 1625 nm).

Meanwhile, the mirror 150 is configured such that some of visible light in the wavelength is reflected by the reflective surface A, while some other of visible light in wavelength is penetrated through the reflective surface A and the second mirror piece 152, and the optical signal is totally reflected by the reflective surface A and exited through the exit surface C. Accordingly, the visible light being penetrated make it possible to passive align the array lens 153 of the incidence surface B and the array lens 154 of the exit surface C by visual observation.

Herein, the array lens 153 of the incidence surface B and the array lens 154 of the exit surface C are the same collimate lens, and they may be passively aligned such that they correspond to each other regardless of order and be bonded to the mirror 150.

For example, the array lens 153 is bonded to the center of the incidence surface B, and the visible light enters to the incidence surface B. Some of entered light is reflected by the reflective surface A, and the location of the array lens 153 is confirmed visually precisely using the light that proceeded to the exit surface C. Therefore, the array lens 153 of the incidence surface B may be mounted precisely such that the optical signal that entered the array lens 153 reaches the array lens 154 of the exit surface C.

In an embodiment, the array lens 153, 154 are each configured to include the same number of lens as the number of channels of the entering optical signals or the number of channels of the array optical receiving element unit 130. For example, when the number of channels of the entering optical signals or the array optical receiving elements unit 130 is four, the number of lens that the array lens 153, 154 each includes may be four.

Meanwhile, explanation on the passive alignment and mounting of the mirror 150 on the metal optical bench 140 such that the optical signals exiting through the array lens 154 reach the exact position of the array optical receiving element unit 130 will be explained with reference to FIG. 5.

FIG. 5 is a perspective view of a method for forming and aligning a mirror on the metal optical bench and above the submount illustrated in FIG. 2. Referring to FIG. 5, the multi-channel optical module 100 forms the mirror 150 on the metal optical bench 140.

The mirror 150 is formed on the metal optical bench 140 and it is aligned with the array optical receiving element unit 130 using the passive alignment method. That is, the mirror 150 mounted on the metal optical bench 140 is passively aligned with array optical receiving element unit 130 by visual method such that some of the visible light in the wavelength band entering to the incidence surface D penetrates the reflective surface A and exits through the array lens 154 integrated on the exit surface C, and reaches to the optical receiving elements of the array optical receiving element unit 130 on the submount 110.

In an embodiment, the aforementioned passive alignment uses the characteristics of the visible light entering the incidence surface D, and being penetrated through the reflective surface A, and reaching to the array optical receiving element unit 130 through the exit surface C.

Meanwhile, the mirror 150 further includes array lens 153, 154 each formed on the incidence surface B and exit surface C. First of all, an optical signal entering the mirror 150 enters the incidence surface B through the array lens 153, and is then totally reflected by the reflective surface A, thereby changing the proceeding path downward, and then exists the array lens 154 through the exit surface C until it reaches the array optical receiving element unit 130.

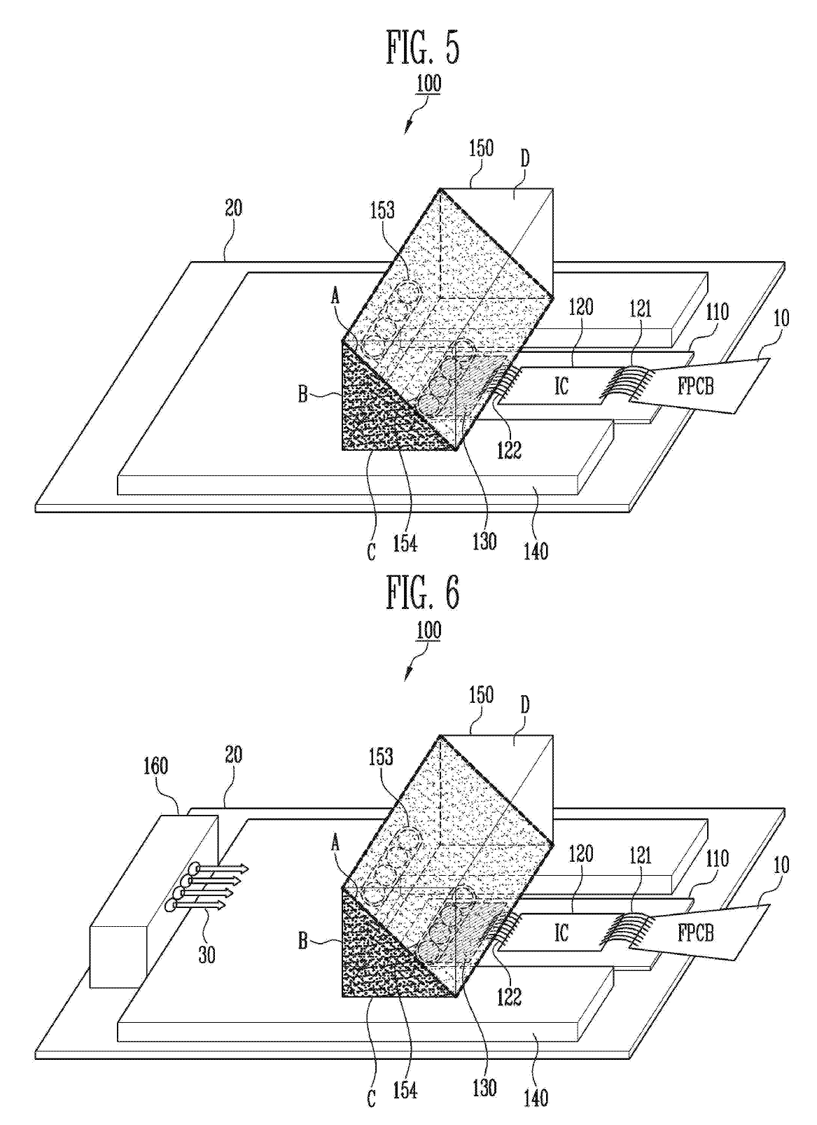

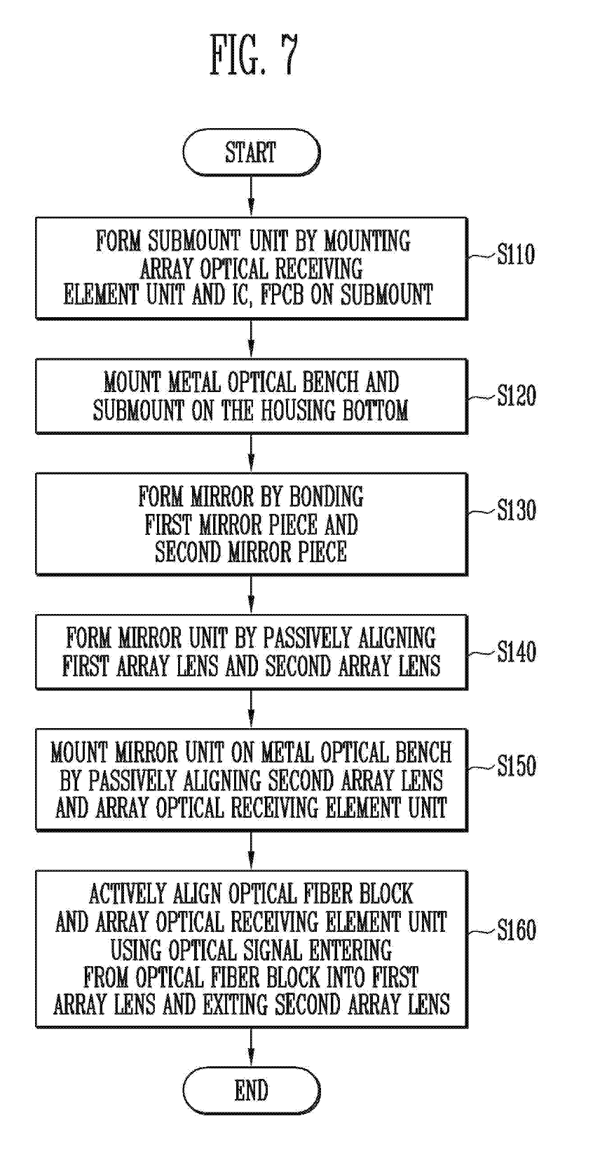

FIG. 6 is a perspective view of a final configuration of the multi-channel optical module according to an embodiment of the present disclosure. With reference to FIG. 6, with the submount 110, metal optical bench 140, and mirror 150 of FIG. 5, the multi-channel array optical fiber block 160 is mounted on the multi-channel optical module, ultimately completing the multi-channel optical module 100.

Meanwhile, in FIG. 6, it is illustrated that the multi-channel array optical fiber block 160 is mounted on the housing bottom 20, but there is no limitation thereto. For example, the multi-channel array optical fiber block 160 may be mounted on the metal optical bench 140 instead of the housing bottom 20.

In FIG. 6, the multi-channel array optical fiber block 160 is arranged and aligned in a three-dimensional active alignment method. As the optical signal 30 transmitted through the array optical fiber of the multi-channel array optical fiber block 160 enters the array lens 153 of the incidence surface B, and then exits the array lens 154 of the exit surface C, and then actively aligned such that the optical efficiency of the optical signal entering the array optical receiving element unit 130 mounted on the submount 110 reaches the maximum level, a final multi-channel optical module 100 is manufactured. Herein, as illustrated in FIG. 6, using the metal optical bench 140 wherein one side is depressed and the mirror 150 having a cubic form, it is possible to actively align the multi-channel array optical fiber block 160 and the array optical receiving element unit 130. The technical means of the three dimensional active alignment of finding a point where the efficiency of optical signal received or transmitted through automatic or manually operated alignment equipment, laser welding equipment, etc, is the maximum value in consideration of the strength and weakness of the optical signal, and optical signal transmitting or receiving method is well known, and thus detailed explanation is omitted herein.

According to the aforementioned configurations, a multi-channel optical module is provided where an optical coupling efficiency between elements is improved using both a passive alignment and active alignment. Such a multi-channel optical module is applicable to a single mode signal transmission for a large volume high speed long distance data transmission.

Furthermore, by combining the passive alignment and active alignment method and then using the same, it is possible to align each element of the multi-channel optical module precisely, and accordingly, optical signal loss is minimized. Furthermore, by partially utilizing the passive alignment, the overall manufacturing cost of the multi-channel optical module is relatively reduced.

For example, unless the invention disclosed in the present specification is used, mounting or forming each of the multi-channel array optical fiber block 160, array lens 153, 154, and array optical receiving element unit 130 has to depend on the three dimensional active alignment, which would lead to significant optical coupling loss, and increase of packaging cost. On the other hand, according to the invention disclosed in the present specification, since the multi-channel optical module is manufactured using the two dimensional passive alignment method and three dimensional active alignment method together, it is possible to improve the optical coupling efficiency, and mass production, and further, it is possible to achieve price reduction due to the improvement of yield and reliability, and the reduction of packaging time.

FIG. 7 is a flowchart schematically illustrating a method for manufacturing a multi-channel optical module according to an embodiment of the present specification. With reference to FIG. 7, the method for manufacturing the multi-channel optical module includes step S110 to step S160.

At step S110, the array optical receiving element unit 130 (see FIG. 1) and IC 120 (see FIG. 1) and FPCB 10 (see FIG. 1) are mounted on the submount (110, see FIG. 1) to form a submount unit. The submount unit refers to a component that includes an array optical receiving element unit 130, IC 120, or FPCB 10.

At S120, a metal optical bench 140 (see FIG. 2) and submount 110 (see FIG. 2) are formed on the housing bottom 20 (see FIG. 2).

At S130, the first mirror piece 151 (see FIG. 3) and the second mirror piece 152 (FIG. 3) are bonded to each other to form the mirror 150 (see FIG. 3). The mirror 150 refers to a component that includes the first mirror piece 151 and second mirror piece 152.

At S140, the first array lens 153 (see FIG. 4) formed on the incidence surface B (see FIG. 4) of the mirror 150 (see FIG. 4) and the second array lens 154 (see FIG. 4) formed on the exit surface C (see FIG. 4) are passively aligned to form the mirror unit. The mirror unit refers to a component that includes a first array lens 153, second array lens 154, and mirror 150.

In an embodiment, the passive alignment of the first array lens 153 and second array lens 154 may be a passive alignment that is performed visually using the visible light.

At S150, in order to have the optical signal 30 (see FIG. 6) exiting the second array lens 154 to reach an exact position of the array optical receiving element unit 130, the mirror unit is arranged and fixed on the metal optical bench 140 (FIG. 5) such that the second array lens 154 is passively aligned with the array optical receiving element unit 130 on the submount 110 (see FIG. 5).

Herein, the metal optical bench 140 may be configured such that one side is depressed, and the submount 110 may be placed on the depressed part of the metal optical bench 140.

In an embodiment, the passive alignment between the mirror 150 and the array optical receiving element unit 130 may be a passive alignment being performed visually using visible light.

At S160, the multi-channel array optical block 160 is actively aligned with the array receiving element unit 130 using the optical signal 30 (see FIG. 6) light entering from the multi-channel array optical fiber block 160 (see FIG. 6) to the first array lens 153 and exiting the second array lens 154 so as to complete the final multi-channel optical module 100 (see FIG. 6).

Meanwhile, further explanation on the passive alignment and active alignment not explained herein is the same as mentioned above.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A method for manufacturing a multi-channel optical module comprising:
forming a mirror unit by passively aligning a first array lens and a second array lens to each other such that an optical signal that enters from the first array lens formed on an incidence surface of a mirror reaches to the second array lens formed on an exit surface of the mirror;
passively aligning the mirror unit to an array optical receiving element unit such that the optical signal that exits the second array lens reaches a predetermined position of the array optical receiving element unit; and
actively aligning a multi-channel array optical fiber block configured to transmit the optical signal to the first array lens of the mirror unit using the optical signal such that the optical signal reaches the array optical receiving element.

2. The method for manufacturing a multi-channel optical module according to claim 1,
wherein the array optical receiving element unit on a submount is placed on one side of a metal optical bench depressed towards the inside, and
the mirror unit is arranged and fixed on the metal optical bench.

3. The method for manufacturing a multi-channel optical module according to claim 1,
wherein the passive alignment of the first array lens and the second array lens and the passive alignment of the mirror unit and the array optical receiving element unit are performed by visually confirming a proceeding path of visible light.

4. The multi-channel optical module according to claim 2,
wherein a thickness of the metal optical bench corresponds to a focal distance of the second array lens, a thickness of the submount, and a thickness of the array optical receiving element unit.
